(19) United States
(12) Patent Application Publication
(10) Pub. No.: US 2017/0367150 A1
(43) Pub. Date: Dec. 21, 2017

(54) WINDOW GLASS HEATING DEVICE

(71) Applicant: Toyota Jidosha Kabushiki Kaisha, Toyota-shi Aichi-ken (JP)

(72) Inventor: Hajime Nagae, Toyota-shi Aichi-ken (JP)

(21) Appl. No.: 15/622,917

(22) Filed: Jun. 14, 2017

(30) Foreign Application Priority Data
Jun. 17, 2016 (JP) 2016-120967

(51) Int. Cl. H05B 3/86; H05B 1/02

(52) U.S. Cl. CPC H05B 3/86; H05B 1/0236; H05B 1/02; H05B 2203/035

(57) ABSTRACT

A window glass heating device includes: a battery mounted in a vehicle; a power supply source configured to supply electric power to the battery; a heating wire configured to generate heat upon reception of electric power, the heating wire being disposed to heat a particular part of a window glass of the vehicle; and a control unit configured to control a supply state of electric power supplied to the heating wire. The control unit is configured to: set the supply state to a first state, when the power supply source supplies electric power to the battery; and set the supply state to a second state, when the power supply source does not supply electric power to the battery, the second state being smaller in an amount of electric power supplied to the heating wire than the first state.

### CROSS-REFERENCE TO RELATED APPLICATIONS

This application claims priority to Japanese Patent Application No. 2016-120967 filed on Jun. 17, 2016 which is incorporated herein by reference in its entirety including the specification, drawings and abstract.

### BACKGROUND

### 1. Technical Field

The present disclosure relates to a window glass heating device.

### 2. Description of Related Art

Some vehicles having a camera for a preventive safety system include a heating device (which is referred to as “device according to the related art”) to prevent fogging of a portion of a window glass (for example, a windshield glass or a rear glass) in front of the camera.

The device according to the related art includes a heating wire (which is referred to as “camera heating wire”) for heating the portion of the window glass in front of the camera. The heating wire is energized when energization of the heating wire is requested (see, for example, EP Patent Application Publication No. 2644005).

The camera heating wire consumes a large amount of electric power as compared with electrical components, such as audio devices and car navigation devices. The camera heating wire in the device according to the related art receives electric power from power supply sources including: a low-voltage battery (which is referred to as “battery” below) such as 12V lead storage batteries; a power generator (alternator); and an external power supply (which are referred to as “other power supply sources” below).

### SUMMARY

However, in the device according to the related art, when electric power is not supplied from a power supply source other than the battery due to such reasons as the power generator being in a disabled state, electric power is supplied to the camera heating wire only from the battery. As a result, a remaining capacity of the battery rapidly decreases.

Accordingly, when electric power is supplied to the camera heating wire only from the battery, there is a possibility that the remaining amount of the battery decreases to the level where the battery is in an insufficient charging state. Therefore, there is a possibility that battery exhaustion occurs due to such reasons as electric power being supplied from the battery so as to operate other electrical systems (such as an air-conditioner) or electric appliances included in the vehicle while the battery is in the insufficient charging state.

The present disclosure provides a window glass heating device (which may be referred to as “device according to the present disclosure”) that less likely to cause battery exhaustion.

An aspect of the present disclosure provides a window glass heating device. The window glass heating device according to the present disclosure includes: a battery mounted in a vehicle; a power supply source configured to supply electric power to the battery to charge the battery; a heating wire configured to generate heat upon reception of electric power, the heating wire being disposed so as to heat a particular part of a window glass of the vehicle, the particular part being located in front of a camera that photographs an outside of the vehicle from an inside of the vehicle through the window glass; and a control unit configured to control a supply state of electric power supplied to the heating wire. The control unit is configured to: set the supply state to a first state, when the power supply source supplies electric power to the battery; and set the supply state to a second state, when the power supply source does not supply electric power to the battery, the second state being smaller in an amount of electric power supplied to the heating wire than the first state.

According to the above aspect, when electric power is not supplied to the heating wire from another power supply source, energization of the heating wire is not performed or the power consumption of the heating wire is reduced. Therefore, it becomes possible to reduce the amount of electric power supply from the battery to the heating wire.

Therefore, it becomes possible to lower the possibility that the remaining amount of the battery decreases to the level where the battery is in the insufficient charging due to the electric power being supplied to the heating wire only from the battery. As a result, it becomes possible to lower the possibility that battery exhaustion easily occurs due to such reasons as electric power being supplied from the battery to another electric system (air-conditioner) or electric appliances included in the vehicle while the battery is in the insufficient charging state.

In the aspect of the present disclosure, the control unit may include a voltage sensor that detects voltage of the battery. And the control unit may switch the supply state between an energized state where electric power is supplied to the heating wire and a cutoff state where supply of electric power to the heating wire is stopped, and the control unit may be configured to: set the energized state to the first state by repeating an energization control mode including continuing the energized state for a first time in a predetermined time and then continuing the cutoff state for a second time that is equal to a remainder obtained by subtracting the first time from the predetermined time; and decrease the first time as the detected voltage of the battery is higher.

According to the above aspect, the first time becomes shorter as the detected voltage of the battery is higher. This makes it possible to lower the possibility of the amount of heat generated by the heating wire becoming too large. As a result, it becomes possible to lower the possibility of heat deterioration of a heated portion around the camera heated with the heating wire.

In the above aspect, the control unit may be configured to, when the power supply source does not supply electric power to the battery, set the supply state to the second state, by repeating an energization control mode including continuing the energized state for a third time and then continuing the cutoff state for a fourth time that is equal to a remainder obtained by subtracting the third time from the predetermined time. The third time is shorter than the first time, when the detected voltage of the battery is a prescribed voltage.

According to the above aspect, even when no electric power is supplied to the heating wire from another power supply source, the electric power is supplied to the heating wire in a low-electric power supply state. As a result, the particular part of the window glass can be warmed. Accordingly, the particular part of the window glass can be warmed as much as possible, so that defogging can immediately be executed once the electric power is supplied to the heating wire from the other power supply source.

Therefore, the fogging of the particular part of the window glass can be eliminated in a shorter time after the electric power is supplied to the heating wire from the other power supply sources. As a result, when a driver of the vehicle starts driving, the fogging of the particular part of the window glass can be eliminated more quickly.

In the aspect of the present disclosure, the control unit may switch the supply state between an energized state where electric power is supplied to the heating wire and a cutoff state where supply of electric power to the heating wire is stopped. The control unit may be configured to: when setting the supply state to the first state, repeat an energization control including continuing the energized state for a first time and then continuing the cutoff state for a second time that is equal to a remainder obtained by subtracting the first time from a predetermined time; and when the power supply source does not supply electric power to the battery, set the supply state to the second state by repeating an energization control mode including continuing the energized state for a third time and then continuing the cutoff state for a fourth time that is equal to a remainder obtained by subtracting the third time from the predetermined time. The third time is shorter than the first time.

In the aspect of the present disclosure, the control unit may be configured to, when the power supply source does not supply electric power to the battery, repeat set the supply state to the second state by repeating an energization control mode including continuing the energized state for a fifth time and then continuing the cutoff state for a sixth time that is equal to a remainder obtained by subtracting the fifth time from the predetermined time, and the fifth time may be set, regardless of the detected voltage of the battery, equal to or shorter than a shortest continuation time among the first e.

According to the above configuration, even when no electric power is supplied to the heating wire from another power supply source, the particular part of the window glass can be warmed since electric power is supplied to the heating wire in the low-electric power supply state. Accordingly, the particular part of the window glass can be warmed as much as possible, so that defogging can immediately be executed once the electric power is supplied to the heating wire from the other power supply source.

Therefore, the fogging of the particular part of the window glass can be eliminated in a shorter time after electric power is supplied to the heating wire from the other power supply source. As a result, when a driver of the vehicle starts driving, the fogging of the particular part of the window glass can be eliminated more quickly.

In the aspect of the present disclosure, the heating wire may be attached to a support member that supports the camera to the vehicle the camera, and the window glass, so as to heat a closed space formed with the support member.

In the aspect of the present disclosure, when the power supply source does not supply electric power to the battery, the control unit may set the supply state to the second state by continuing a cutoff state where supply of electric power to the heating wire is stopped.

According to the aspect, since the space between the camera and the window glass is a closed space, the temperature of the space easily rises. This makes it possible to facilitate elimination of the fogging generated in the particular part of the window glass in front of the camera with a low electric power amount or to prevent the fogging from being generated.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a front view of a vehicle including a camera heater (first heating device) according to a first embodiment of the present disclosure;

FIG. 1B is a side view of the vehicle including the camera heater (first heating device) according to the first embodiment;

FIG. 2 illustrates a system including the camera heater illustrated in FIGS. 1A and 1B;

FIG. 3 is a flowchart illustrating a routine executed by a CPU of an electronic control unit (main ECU) illustrated in FIGS. 1A and 1B;

FIG. 4 is a flowchart illustrating a routine executed by the CPU of a camera electronic control unit (camera ECU) illustrated in FIGS. 1A and 1B;

FIG. 5 is a flowchart illustrating a routine executed by a camera CPU in a second heating device;

FIG. 6 illustrates a system of a vehicle to which a third heating device is applied;

FIG. 7 is a flowchart illustrating a routine executed by the CPU of a hybrid ECU included in the vehicle to which the third heating device is applied;

FIG. 8 illustrates a system of a vehicle to which a fourth heating device is applied; and

FIG. 9 is a flowchart illustrating a routine executed by the CPU of a hybrid ECU included in the vehicle to which the fourth heating device is applied.

### DETAILED DESCRIPTION OF THE PREFERRED EMBODIMENTS

Hereinafter, a heating device according to the embodiments of the present disclosure will be described with reference to the accompanying drawings. Throughout the drawings of the embodiments, identical or corresponding components are designated by identical reference signs. The embodiments described below or the equivalent thereof are merely preferred examples of the present disclosure. The contents of the present disclosure are not restricted by the embodiments or the equivalent thereof.

### First Embodiment

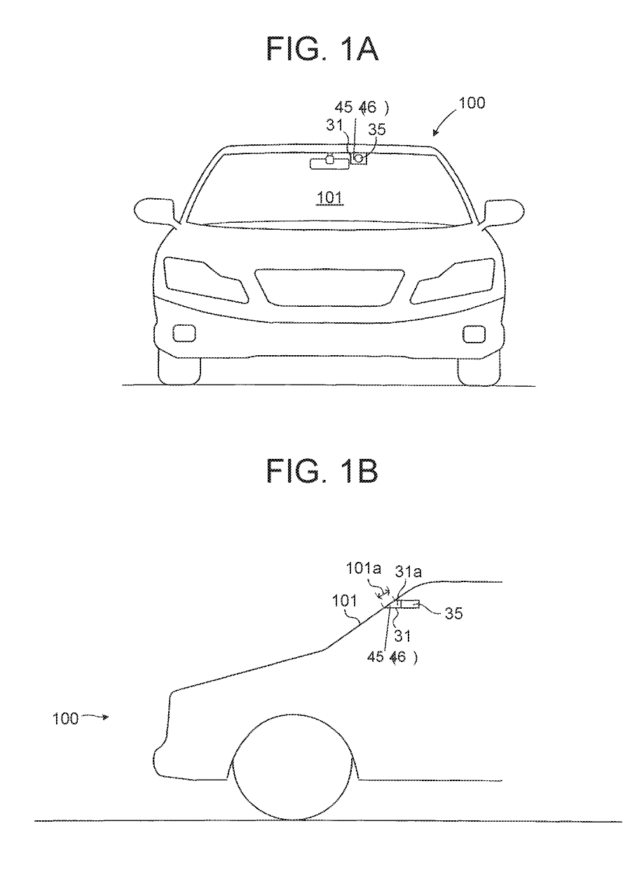

Hereinafter, a window glass heating device (which is referred to as “first heating device”) according to the first embodiment of the present disclosure will be described with reference to the drawings. The first heating device is applied to a vehicle 100 illustrated in FIGS. 1A and 1B.

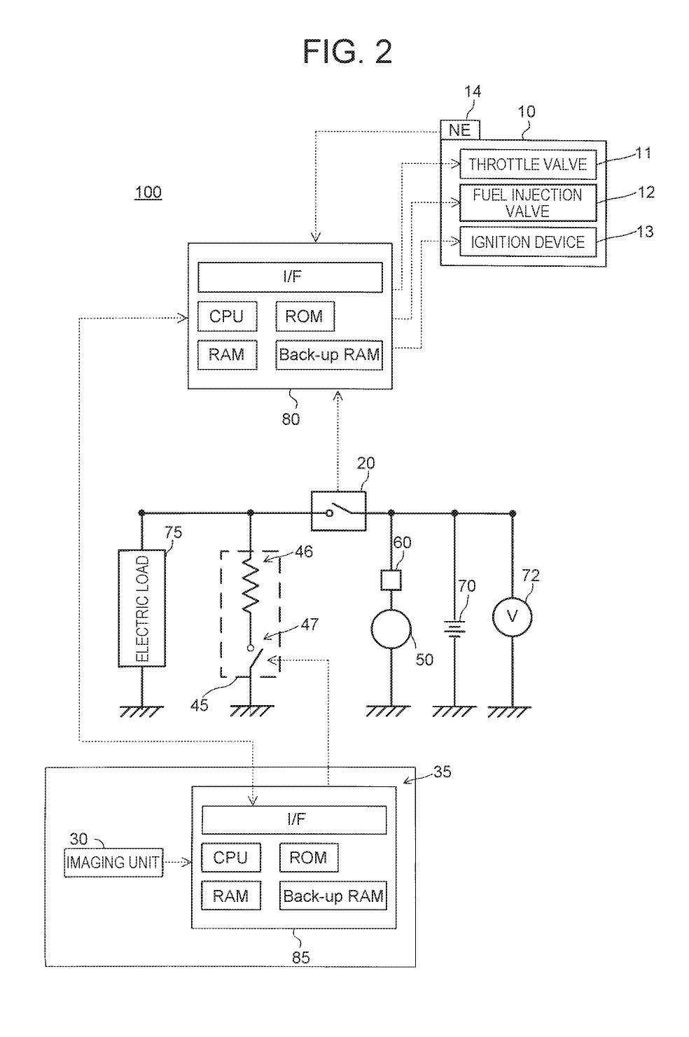

As illustrated in FIGS. 1A, 1B, and 2, the vehicle 100 includes an internal combustion engine 10, an ignition switch 20, a camera 35, a camera heater 45 as a window glass heating device, an alternator 50 as a power generator, a rectifier 60, a battery 70, a voltage detector 72, an electric load 75, and a main electronic control unit (which is referred to as “main ECU” below) 80.

The internal combustion engine 10 (which is simply referred to as “the engine 10” below) is a multi-cylinder (four-cylinder in this example) four-cycle spark ignition-type gasoline engine. As illustrated in FIG. 2, the engine 10 includes a throttle valve 11, a fuel injection valve 12, and an ignition device 13. The engine 10 includes an NE sensor 14 that detects an engine speed NE of the engine 10.

The throttle valve 11 is disposed on an intake pipe of the engine 10 which is not illustrated. The throttle valve 11 is connected to a main ECU 80. The main ECU 80 drives the throttle valve 11 so that an opening TA of the throttle valve 11 reaches a target value TAtgt.

The fuel injection valve 12 is disposed so as to inject fuel to an intake port of the engine 10 which is not illustrated. The fuel injection valve 12 is connected to the main ECU 80. The main ECU 80 drives the fuel injection valve 12 so that the quantity Q of the fuel injected from the fuel injection valve 12 reaches a target value Qtgt.

The ignition device 13 is disposed so as to be able to ignite an air fuel mixture formed in a combustion chamber of the engine 10 which is not illustrated. The ignition device 13 is connected to the main ECU 80. The main ECU 80 drives the ignition device 13 so that the ignition device 13 ignites the air fuel mixture at specified timing.

The ignition switch 20 is operated by a driver (user) of the vehicle 100. The ignition switch 20 is connected to the main ECU 80. When the driver sets the ignition switch 20 to an ON position while driving (engine operation) of the engine 10 is stopped, the main ECU 80 starts operation of the engine 10. As a result, the vehicle 100 is put in a travelable state. When the driver sets the ignition switch 20 to an OFF position during engine operation, the main ECU 80 stops the engine operation. As a result, the vehicle 100 is put in an untravelable state.

The camera 35 is disposed inside the vehicle 100, i.e., inside a windshield glass 101 that is one of front window glasses of the vehicle 100 as illustrated in FIGS. 1A and 1B. The camera 35 is supported to the vehicle 100 with a bracket (supporting member) 31. The bracket 31 is made of a resin material.

The camera 35 photographs the outside of the vehicle 100 from the inside of the vehicle 100 through the windshield glass 101. As illustrated in FIG. 2, the camera 35 has an imaging unit 30 and a later-described camera electronic control unit (which is referred to as “camera ECU” below) 85. The photographing data formed by the imaging unit 30 of the camera 35 is transmitted to the camera ECU 85. The camera ECU 85 transmits the received photographing data to the main ECU 80.

The main ECU 80 uses the photographing data received from the camera ECU 85 to perform control including inter-vehicle distance control that maintains a specified distance (inter-vehicle distance) between the vehicle 100 and a vehicle (leading vehicle) traveling ahead of the vehicle 100, lane maintaining control that recognizes white lines of a traveling lane of the vehicle 100 and changes the steering angle of an unillustrated steering wheel in order to keep the vehicle 100 within the traveling lane, and collision avoidance control that recognizes an obstacle present ahead of the vehicle 100, and operates an unillustrated braking device in order to avoid collision of the vehicle 100 with the obstacle.

The camera heater 45 (which is simply referred to as “heater 45” below) illustrated in FIG. 2 is disposed on the bracket 31 so as to heat space 31a in front of the camera 35, the space 31a being surrounded with the bracket 31 as illustrated in FIG. 1B. Specifically, the space 31a is a closed space surrounded with the camera 35, the bracket 31, and the windshield glass 101. Therefore, the heater 45 is disposed on a portion of the bracket 31 between the camera 35 and the windshield glass 101.

The heater 45 includes a heater heating wire 46 and a heater circuit switch 47. The heater heating wire 46 has one end connected to one terminal of the alternator 50 through the ignition switch 20 and the rectifier 60. The heater heating wire 46 has the other end connected to one end of the heater circuit switch 47. The other end of the heater circuit switch 47 is grounded. Furthermore, the heater circuit switch 47 is connected to the camera ECU 85, so that the state of the heater circuit switch 47 can be set to either an ON (electrically connected) state or an OFF (electrically disconnected, cutoff) state in response to an instruction signal from the camera ECU 85.

The alternator 50 is rotationally driven by a crankshaft of the engine 10 which is not illustrated. The alternator 50 is a power generator that generates electric power when the alternator 50 is driven by the engine 10 during engine operation. The other terminal of the alternator 50 is grounded.

At least some of the electric power generated by the alternator 50 is supplied to the heater heating wire 46 through the rectifier 60, when both the ignition switch 20 and the heater circuit switch 47 are set to the ON state. In short, the heater heating wire 46 is energized. The remaining electric power is used to charge the battery 70 through the rectifier 60, or some of the remaining electric power is supplied through the rectifier 60 to the camera 35 and an electric load 75 (such as an air-conditioner) included in the vehicle 100.

When the heater heating wire 46 is energized, the space 31a is heated with the heat generated by the heater heating wire 46. As a result, a particular part 101a of the windshield glass 101 in front of the camera 35 is heated. As a consequence, when the particular part 101a of the windshield glass 101 is fogged with moisture, the particular part 101a is defogged by heating. When the particular part 101a of the windshield glass 101 is not fogged, heating prevents the particular part 101a from fogging.

When the heater circuit switch 47 is set to the OFF state, the electric power generated by the alternator 50 is not supplied to the heater heating wire 46. That is, energization to the heater heating wire 46 with the electric power supplied from the alternator 50 is stopped.

Specifically, the battery 70 is a low-voltage secondary battery. More specifically, the battery 70 is a lead storage battery with a voltage of about 12V. When both the ignition switch 20 and the heater circuit switch 47 are set to the ON state, electric power is supplied to the heater heating wire 46 also from the battery 70 as necessary. That is, the heater heating wire 46 is energized.

The voltage detector 72 is provided in order to detect the battery voltage supplied to the heater heating wire 46.

The electric load 75 is another electrical system (air-conditioner) or an electric appliance included in the vehicle 100 which receive electric power from the battery 70 and the alternator 50.

The main electronic control unit (i.e., main ECU) 80 as a control unit is a known electronic circuit including a microcomputer. The main ECU 80 includes component members such as a CPU, a ROM, a RAM, a backup RAM, and an interface. The CPU implements various functions by executing routines (programs, instructions) stored in the ROM.

When the ignition switch 20 is set to the ON state, the main ECU 80 drives the throttle valve 11, the fuel injection valve 12, and the ignition device 13 to start engine operation in response to a signal from the ignition switch 20. When the ignition switch 20 is set to the OFF state, the main ECU 80 stops driving of the throttle valve 11, the fuel injection valve 12, and the ignition device 13 to stop engine operation in response to the signal from the ignition switch 20.

The camera electronic control unit (i.e., camera ECU) 85 as a control unit is a known electronic circuit including a microcomputer. The camera ECU 85 includes component members such as a CPU, a ROM, a RAM, a backup RAM, and an interface. The CPU implements various functions by executing routines (programs, instructions) stored in the ROM.

The camera ECU 85 sets the heater circuit switch 47 to either the ON state or the OFF state. As described before, when the camera ECU 85 sets the heater circuit switch 47 to the ON state during engine operation, the heater heating wire 46 is energized. When the camera ECU 85 sets the heater circuit switch 47 to the OFF state, the energization of the heater heating wire 46 is stopped.

<Outline of Operation>

The main ECU 80 first determines whether or not permission conditions to energize the heater heating wire 46 are satisfied. When the permission conditions to energize the heater heating wire 46 are satisfied, the main ECU 80 determines whether or not electric power is supplied to the heater heating wire 46 from the alternator 50 that is a power supply source other than the battery 70.

When electric power is supplied to the heater heating wire 46 from another power supply source, the main ECU 80 instructs to the camera ECU 85 permission of executing energization control of the heater heating wire 46 (which is also referred to as “heating wire energization control” below). Upon reception of the instruction of permitting the heating wire energization control from the main ECU 80, the camera ECU 85 executes the heating wire energization control.

When executing the heating wire energization control, the camera ECU 85 alternately repeats energizing the heater heating wire 46 over specified energization continuation time Ton, and stopping energization of the heater heating wire 46 over specified energization stop time Toff. The sum of the energization continuation time Ton and the energization stop time Toff is constant. During the heating wire energization control, the state of electric power supply to the heater heating wire 46 is also referred to as “the first state” for convenience. It is to be noted that the camera ECU 85 controls the state of electric power supply to the heater heating wire 46 by setting different values as the energization continuation time Ton and the energization stop time Toff in accordance with voltages supplied to the heater heating wire 46.

When no electric power is supplied to the heater heating wire 46 from another power supply source, the main ECU 80 instructs to the camera ECU 85 prohibition of executing the heating wire energization control. That is, in the state where no voltage (electric power) is supplied from the alternator 50, the main ECU 80 instructs prohibition of executing the heating wire energization control to the camera ECU 85. Upon reception of the instruction of prohibition of the heating wire energization control from the main ECU 80, the camera ECU 85 continues a non-execution state of the heating wire energization control when the heating wire energization is not executed. When the heating wire energization control is under execution, the camera ECU 85 stops the heating wire energization control under execution so as to set the state of electric power supply to the heater heating wire 46 to a power supply stop state. The power supply stop state is also referred to as “the second state” for convenience.

<Specific Operation>

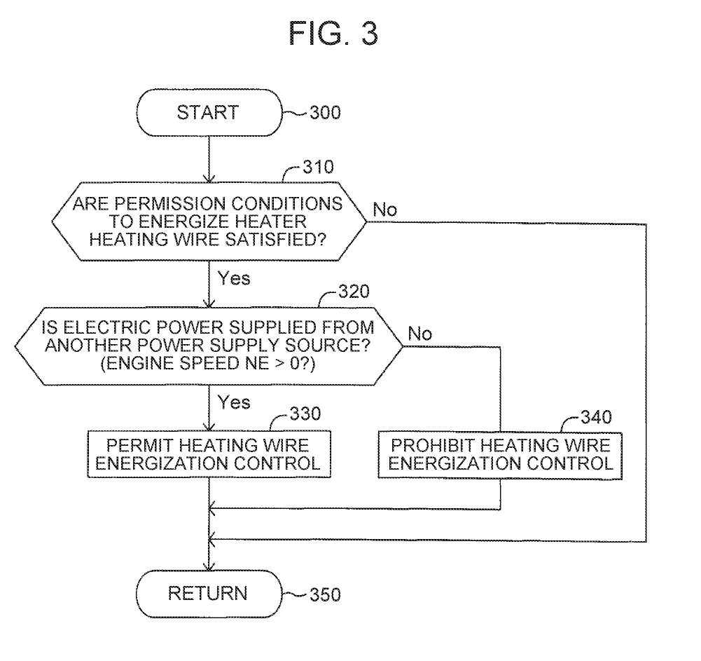

A description is now given of specific operation of the first heating device. The CPU of the main ECU 80 (which is simply referred to as “main CPU” below) executes a routine in the flowchart illustrated in FIG. 3 whenever predetermined time elapses. Therefore, at specified timing, the main CPU starts processing from step 300, and advances the processing to step 310 to determine whether or not the permission conditions to energize the heater heating wire 46 are satisfied.

Specifically, the energization permission conditions include following conditions 1 to 3. The main CPU determines whether or not all the following energization permission conditions are satisfied. 1. Outside air temperature detected by an outside air temperature sensor, which is not illustrated, is within a threshold (a given value is determined as the threshold based on the temperature at which the windshield glass 101 is not fogged). 2. The voltage (i.e., the voltage detected by the voltage detector 72) supplied to the heater heating wire 46 is equal to or less than a prescribed value (a given value is determined as the prescribed value based on the voltage value at which the heater heating wire 46 may be damaged. The voltage value may properly be obtained by, for example, an experiment and the like). 3. Information on wheel speed can be acquired.

When the permission conditions to energize the heater heating wire 46 are satisfied, the main CPU determines “Yes” in step 310, and advances the processing to step 320 described later. When the permission conditions to energize the heater heating wire 46 are not satisfied, the main CPU determines “No” in step 310, and advances the processing to step 350, where the present routine is temporarily ended.

In step 320, the main CPU determines whether or not electric power is supplied to the battery 70 from another power supply source.

Specifically, when the engine speed NE detected by the NE sensor 14 is larger than a specified positive value (i.e., when the alternator 50 generates electric power), the main CPU determines “Yes” in step 320, and advances the processing to step 330. Then, in step 330, the main CPU sends out to the camera ECU 85 a signal that instructs permission of the heating wire energization control.

When the engine speed NE detected by the NE sensor 14 is “0” (i.e., the alternator 50 does not generate electric power, and the electric power is not supplied to the heater heating wire 46 nor the battery 70 from the alternator 50), the main CPU determines “No” in step 320, and advances the processing to step 340. Then, in step 340, the main CPU sends out to the camera ECU 85 a signal that instructs prohibition of the heating wire energization control.

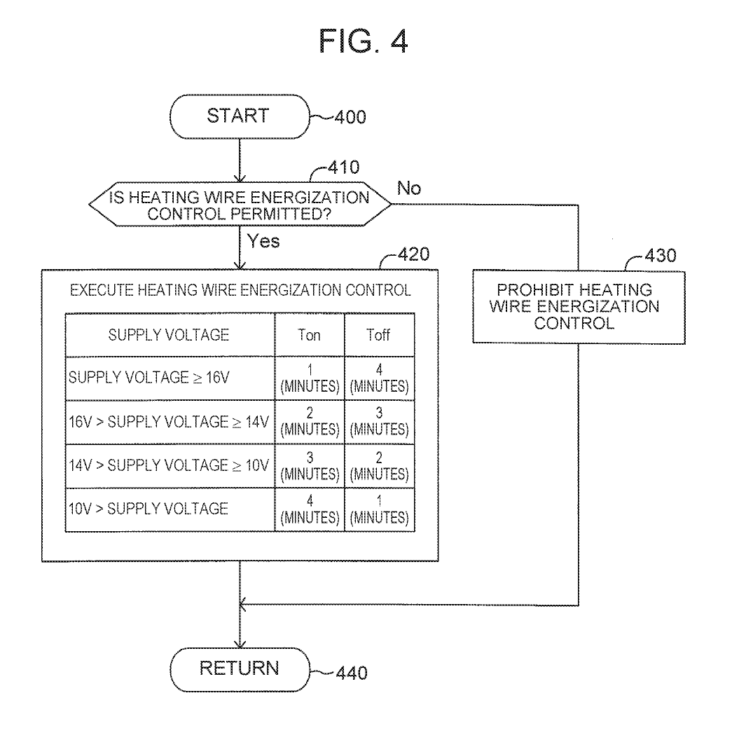

The CPU of the camera ECU 85 (which is simply referred to as “camera CPU” below) executes a routine in the flowchart illustrated in FIG. 4 whenever predetermined time elapses. Therefore, at specified timing, the camera CPU starts processing from step 400, and advances the processing to step 410 to determine whether or not the heating wire energization control is permitted based on a signal received from the main CPU.

When the heating wire energization control is permitted, the camera CPU determines “Yes” in step 410, and advances the processing to step 420, where the state of electric power supply to the heater heating wire 46 is controlled by performing energization control of the heater heating wire 46 in accordance with the voltage (which is the voltage detected by the voltage detector 72 and which may be referred to as “supply voltage”) supplied to the heater heating wire 46.

Specifically, the camera CPU performs energization control that alternately repeats energizing the heater heating wire 46 (turning on the heater circuit switch 47) over the specified energization continuation time Ton, and stopping energization of the heater heating wire 46 (turning off the heater circuit switch 47) over the specified energization stop time Toff. The energization continuation time Ton is also referred to as “the first time” for convenience. The energization stop time Toff is also referred to as “the second time” for convenience. The second time is equal to a remainder obtained by subtracting the first time from a fixed period of time (Ton+Toff).

In this case, the camera CPU sets the specified energization continuation time Ton and energization stop time Toff corresponding to the supply voltage. Specifically, a plurality of voltage regions (four voltage regions in the first heating device) are set in ascending order of supply voltage. The energization continuation time Ton is so set that the voltage regions higher in supply voltage have a shorter energization continuation time Ton than the voltage regions lower in supply voltage. The energization stop time Toff is so set that the voltage regions higher in supply voltage have a longer energization stop time Toff than the voltage regions lower in supply voltage. This makes it possible to lower the possibility that the amount of heat generated by the heater heating wire 46 becomes too large. As a result, it becomes possible to lower the possibility of heat deterioration of a heated portion around the camera 35 heated by the heater heating wire 46.

Specifically, the energization continuation time Ton and the energization stop time Toff are set as below in accordance with the supply voltage. •When the supply voltage is less than 10V, the energization continuation time Ton is set to 4 minutes, while the energization stop time Toff is set to 1 minute. •When the supply voltage is 10V or more and less than 14V, the energization continuation time Ton is set to 3 minutes, while the energization stop time Toff is set to 2 minutes. •When the supply voltage is 14V or more and less than 16V, the energization continuation time Ton is set to 2 minutes, while the energization stop time Toff is set to 3 minutes. •When the supply voltage is 16V or more, the energization continuation time Ton is set to 1 minute, while the energization stop time Toff is set to 4 minutes. Then, the camera CPU advances the processing to step 440, where the present routine is temporarily ended.

When the heating wire energization control is not permitted in step 410, the camera CPU determines “No” in step 410, and advances the processing to step 430. When the heating wire energization control is not under execution, the camera CPU continues the non-execution state. When the heating wire energization control is under execution, the camera CPU stops the heating wire energization control under execution. That is, the camera CPU turns off the heater circuit switch 47. Then, the camera CPU advances the processing to step 440, where the present routine is temporarily ended.

The specific operation of the first heating device is as described above. As a consequence, the following effects can be obtained. That is, when electric power is supplied to the heater heating wire 46 from the battery 70 while no electric power is supplied to the heater heating wire 46 from a power supply source (alternator 50) other than the battery 70, the remaining capacity of the battery 70 rapidly decreases. On the contrary, in the first heating device, when no electric power is supplied to the heater heating wire 46 from another power supply source (the alternator 50), energization of the heater heating wire 46 is not performed. Therefore, the electric power is not supplied to the heater heating wire 46 from the battery 70.

Therefore, it becomes possible to lower the possibility that the remaining amount of the battery 70 decreases to the level where the battery 70 is in the insufficient charging state due to the electric power being supplied to the heater heating wire 46 only from the battery 70. As a result, it becomes possible to lower the possibility that battery exhaustion easily occurs due to such reasons as electric power being supplied from the battery 70 to operate another electrical system (air-conditioner) or an electric appliances (electric loads 75) included in the vehicle while the battery 70 is in the insufficient charging state.

### Second Embodiment

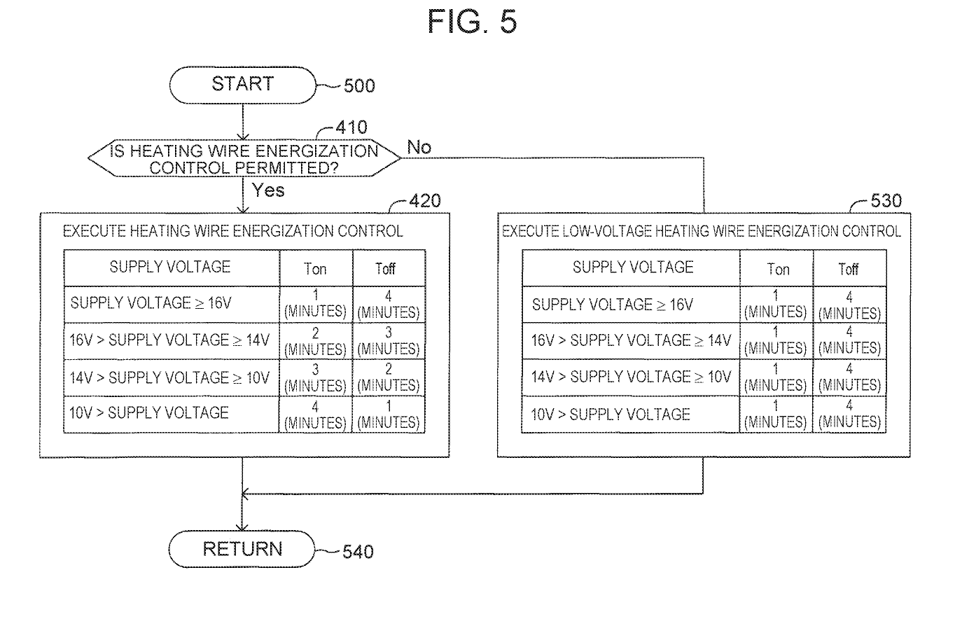

A description is given of a window glass heating device (which is referred to as “second heating device” below) according to the second embodiment of the present disclosure. The second heating device is different from the first heating device only in the following point. That is, in the second heating device, the camera CPU in the camera ECU executes a routine illustrated in FIG. 5 in place of the routine illustrated in FIG. 4. Hereinafter, the point of difference is mainly described.

<Specific Operation>

A description is given of specific operation of the second heating device. At the specified timing, the main CPU of the second heating device performs the processing (steps 300 through 350) same as the steps illustrated in FIG. 3. As a result, the main CPU sends out a signal that instructs permission of the heating wire energization control or prohibition of the heating wire energization control to the camera ECU 85.

At the specified timing, the camera CPU of the second heating device executes the routine illustrated in FIG. 5. At specified timing, the camera CPU starts processing from step 500, and advances the processing to step 410 to determine whether or not the heating wire energization control is permitted based on a signal received from the main CPU.

When the heating wire energization control is permitted, the camera CPU determines “Yes” in step 410, and advances the processing to step 420 to execute the processing thereof. Then, the camera CPU advances the processing to step 540, where the present routine is temporarily ended.

When the heating wire energization control is not permitted in step 410, the camera CPU determines “No” in step 410, and advances the processing to step 530. In step 530, energization control of the heater heating wire 46 is performed such that the electric power consumption of the heater heating wire 46 becomes smaller than that in the case of executing the normal heating wire energization control (step 420).

Specifically, the camera CPU performs low-electric power heating wire energization control that alternately repeats energizing the heater heating wire 46 over specified energization continuation time (which is referred to as “the third time” or “the fifth time” for convenience) Ton described below and stopping energization of the heater heating wire 46 over specified energization stop time (which is referred to as “the fourth time” or “the sixth time” for convenience) Toff described below. That is, the state of electric power supply to the heater heating wire 46 is set to a low-electric power supply state where the amount of electric power supplied to the heater heating wire 46 is smaller than that in the power supply state at the time of executing the normal heating wire energization control (step 420). Also in this case, the sum of Ton and Toff is a constant value that is equal to the sum of “Ton and Toff” used in step 420.

In this case, the camera CPU sets constant energization continuation time Ton and energization stop time Toff regardless of the voltage supplied to the heater heating wire 46. The energization continuation time Ton and the energization stop time Toff are so set that the power consumption of the heater heating wire 46 (electric power amount supplied to the heater heating wire 46) is less than the power consumption of the heater heating wire 46 in the case of performing the normal heating wire energization control.

Specifically, in the low-electric power heating wire energization control, the energization continuation time Ton is set to be shorter than continuation time set in the normal heating wire energization control performed with prescribed voltage, or to be equal to or shorter than the shortest continuation time set in the normal heating wire energization control. The energization stop time Toff is set to be longer than continuation time set in the normal heating wire energization control performed at prescribed voltage, or to be equal to or longer than the longest energization stop time set in the normal heating wire energization control. That is, when the detected battery voltage is a prescribed voltage below 16V, the third time is set to be shorter than the first time, or the fifth time is set to be equal to or shorter than the shortest continuation time among the first times regardless of the detected battery voltage.

Specifically, the energization continuation time Ton is set to 1 minute that is equal to the shortest energization continuation time (1 minute) set in the normal heating wire energization control. The energization stop time Toff is set to 4 minutes that is equal to the longest energization stop time (4 minutes) set in the normal heating wire energization control. Then, the camera CPU advances the processing to step 540, where the present routine is temporarily ended.

The specific operation of the second heating device is as described above. As a consequence, the following effects can be obtained. That is, when electric power is supplied to the heater heating wire 46 from the battery 70 while no electric power is supplied to the heater heating wire 46 from a power supply source (alternator 50) other than the battery 70, the capacity of the battery 70 rapidly decreases.

On the contrary, in the second heating device, when no electric power is supplied to the heater heating wire 46 from another power supply source (alternator 50), the energization continuation time Ton of the heater heating wire 46 is set to be short, and the energization stop time Toff is set to be long. As a result, the power consumption of the heater heating wire 46 is reduced, so that the amount of electric power supplied to the heater heating wire 46 from the battery 70 can be reduced.

Therefore, it becomes possible to lower the possibility that the remaining amount of the battery 70 decreases to the level where the battery 70 is in the insufficient charging state due to the electric power being supplied to the heater heating wire 46 only from the battery 70. As a result, it becomes possible to lower the possibility that battery exhaustion easily occurs due to such reasons as electric power being supplied from the battery 70 to operate another electrical system (air-conditioner) or an electric appliance included in the vehicle while the battery 70 is in the insufficient charging state.

Furthermore, in the second heating device, even when no electric power is supplied to the heater heating wire 46 from another power supply source (alternator 50), the electric power is supplied to the heating wire in a low-electric power supply state. As a result, the particular part 101a of the windshield glass 101 can be warmed.

Accordingly, the particular part 101a of the windshield glass 101 can be warmed as much as possible, so that defogging can immediately be executed once the electric power is supplied to the heater heating wire 46 from another power supply source (alternator 50).

Therefore, the fogging of the particular part 101a of the windshield glass 101 can be eliminated in a shorter time after electric power is supplied to the heater heating wire 46 from another power supply source (alternator 50). As a result, when the driver of the vehicle 100 starts driving, the fogging of the particular part 101a of the windshield glass 101 can be eliminated more quickly.

### Third Embodiment

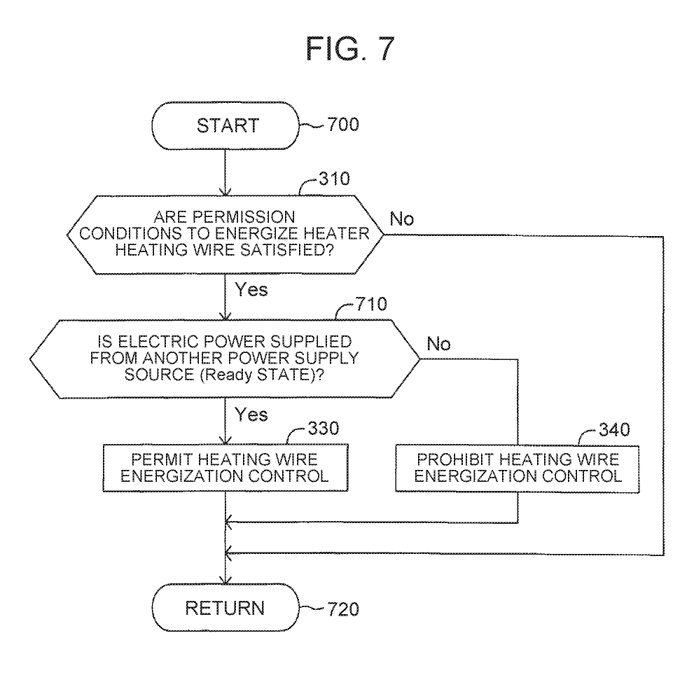

A description is given of a window glass heating device (which is referred to as “third heating device” below) according to the third embodiment of the present disclosure. The third heating device is different from the first heating device only in the following points 1 and 2. That is, 1. the third heating device is applied to a hybrid vehicle including an engine and a generator motor as a driving source. 2. In the third heating device, a hybrid CPU of a hybrid ECU executes a routine illustrated in FIG. 7 in place of the routine illustrated in FIG. 3. Hereinafter, the points of difference are mainly described.

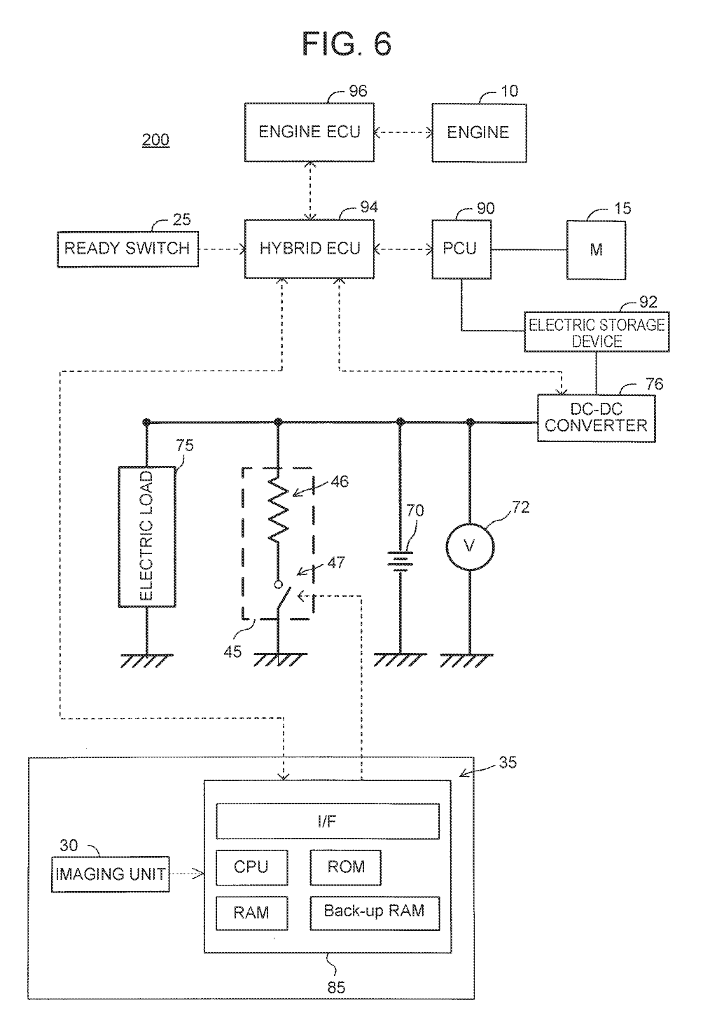

As illustrated in FIG. 6, a vehicle 200 is a hybrid vehicle including a hybrid system. The vehicle 200 includes an engine 10 and a motor 15 that generate driving force for traveling of the vehicle 200, a ready switch 25, a camera 35, a camera heater 45 as a window glass heating device, a battery 70, a voltage detector 72, and an electric load 75. The vehicle 200 also includes a DC-DC converter 76, a power control unit 90, an electric storage device 92, a hybrid electronic control unit (which is referred to as “hybrid ECU”) 94, and an engine electronic control unit (which is referred to as “engine ECU”) 96.

The motor 15 is a synchronous generator-motor which can function as both the power generator and the electric motor.

The ready switch 25 is a system startup switch for the vehicle 200. The ready switch 25 is configured such that the hybrid system is started (put in a Ready state) when the ready switch 25 is operated while a vehicle key, which is not illustrated, is inserted into a key slot and a brake pedal is stepped on.

Specifically, the electric storage device 92 includes a chargeable and dischargeable main battery used as a driving power source of the motor 15, and an SOC (state of charge) sensor (not illustrated) that detects the SOC of the main battery. Specifically, the main battery is a chargeable and dischargeable secondary battery (which may be referred to as “high voltage battery”) with a voltage of 200V or more. The electric power charged in the main battery is stepped down through the DC-DC converter 76, and supplied to the battery 70 so that the battery 70 is charged.

The power control unit 90 supplies electric power to the motor 15 from the electric storage device 92, and performs power regeneration from the motor 15 to the electric storage device 92. The power control unit 90 includes an inverter as a motor drive circuit, and a voltage conversion circuit.

The hybrid ECU 94 is an electronic circuit including a known microcomputer. The hybrid ECU 94 includes component members such as a CPU, a ROM, a RAM, a backup RAM, and an interface. The CPU implements various functions by executing routines (programs, instructions) stored in the ROM.

The hybrid ECU 94 starts the hybrid system, when the ready switch 25 is set to an ON state. Specifically, the vehicle 200 is put in the Ready state when the ready switch 25 is operated while the unillustrated vehicle key is inserted into the key slot and the brake pedal is stepped on as described before.

In the case where the vehicle 200 is in the Ready state, at least some of the electric power, which is supplied through the DC-DC converter 76 from the high voltage battery of the electric storage device 92, is supplied to the heater heating wire 46, when the heater circuit switch 47 is set to the ON state. That is, electric power is supplied to the heater heating wire 46 from a voltage supply source other than the battery 70, so that the heater heating wire 46 is energized. The remaining electric power is used to charge the battery 70, or some of the remaining electric power is supplied to component members such as the camera 35 and another electric system (such as an air-conditioner) included in the vehicle 200.

When the vehicle 200 is not in the Ready state, the electric power, which is supplied through the DC-DC converter 76 from the high voltage battery of the electric storage device 92, is not supplied to the battery 70 nor the heater heating wire 46. That is, electric power is not supplied to the heater heating wire 46 from a voltage supply source other than the battery 70.

The hybrid ECU 94 is connected with the engine ECU 96 in a mutually communicable manner. The hybrid ECU 94 calculates an engine request output value and a motor request torque value (driving torque, regenerative braking torque) based on signals such as a sensor signal indicative of the driver operation amount that is an accelerator operation amount and a brake operation amount, a sensor signal indicative of a motion state of the vehicle 200, and an SOC sensor signal of the electric storage device 92. The hybrid ECU 94 transmits the calculated engine request output value to the engine ECU 96, and also controls operation of the power control unit 90 based on the motor request torque value.

The engine ECU 96 is an electronic circuit including a known microcomputer. The engine ECU 96 includes component members such as a CPU, a ROM, a RAM, a backup RAM, and an interface. The CPU implements various functions by executing routines (programs, instructions) stored in the ROM. The engine ECU 96 controls operation of the engine 10 in accordance with the engine request output value transmitted from the hybrid ECU 94.

<Specific Operation>

A description is given of specific operation of the third heating device. The CPU of the hybrid ECU 94 (which is simply referred to as “hybrid CPU” below) executes a routine in the flowchart illustrated in FIG. 7 whenever predetermined time elapses. Therefore, at specified timing, the hybrid CPU starts processing from step 700, and advances the processing to step 310 to determine whether or not the permission conditions to energize the heater heating wire 46 are satisfied.

When the permission conditions to energize the heater heating wire 46 are satisfied, the hybrid CPU determines “Yes” in step 310, and advances the processing to step 710 described later. When the permission conditions to energize the heater heating wire 46 are not satisfied, the hybrid CPU determines “No” in step 310, and advances the processing to step 720 where the present routine is temporarily ended.

In step 710, the hybrid CPU determines whether or not electric power is supplied to the battery 70 from another power supply source. Specifically, the hybrid CPU determines whether or not the vehicle 200 is in the Ready state in step 710 so as to determine whether or not electric power is supplied to the battery 70 from another power supply source (i.e., the electric storage device 92 through the DC-DC converter 76).

When electric power is supplied to the battery 70 from another power supply source (i.e., when the vehicle 100 is in the Ready state), the hybrid CPU determines “Yes” in step 710 and advances the processing to step 330. Then, in step 330, the hybrid CPU sends out to the camera ECU 85 a signal that instructs permission of the heating wire energization control.

When no electric power is supplied to the battery 70 from another power supply source (i.e., when the vehicle 200 is not in the Ready state), the hybrid CPU determines “No” in step 710, and advances the processing to step 340. Then, in step 340, the hybrid CPU sends out to the camera ECU 85 a signal that instructs prohibition of the heating wire energization control.

Meanwhile, at specified timing, the camera CPU performs the processing same as the steps (steps 400 through 440) illustrated in FIG. 4.

The specific operation of the third heating device is as described above. As a consequence, the following effects can be obtained. That is, when electric power is supplied to the heater heating wire 46 from the battery 70 while no electric power is supplied to the heater heating wire 46 from a power supply source (electric storage device 92) other than the battery 70, the remaining capacity of the battery 70 rapidly decreases. On the contrary, in the third heating device, when no electric power is supplied to the heater heating wire 46 from another power supply source (electric storage device 92), energization of the heater heating wire 46 is not performed. Therefore, the electric power is not supplied to the heater heating wire 46 from the battery 70.

Therefore, it becomes possible to lower the possibility that the remaining amount of the battery 70 decreases to the level where the battery 70 is in the insufficient charging state due to the electric power being supplied to the heater heating wire 46 only from the battery 70. As a result, it becomes possible to lower the possibility that battery exhaustion easily occurs due to such reasons as electric power being supplied from the battery 70 to operate another electrical system (air-conditioner) or an electric appliance included in the vehicle 200 while the battery 70 is in the insufficient charging state.

### Fourth Embodiment

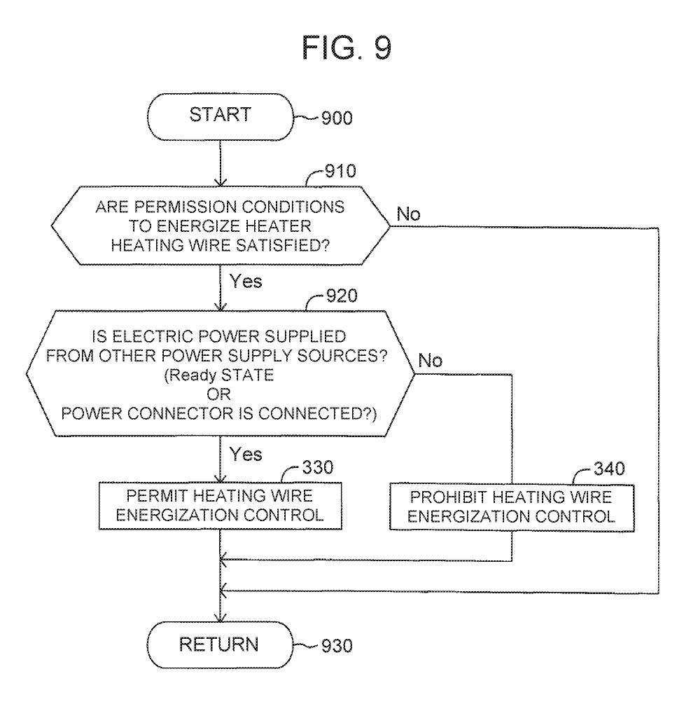

A description is given of a window glass heating device (which may be referred to as “fourth heating device” below) according to the fourth embodiment of the present disclosure. The fourth heating device is different from the third heating device only in the following points 1 and 2. 1. The fourth heating device is applied to a plug-in hybrid vehicle including an engine and a generator motor as a driving source, and being chargeable from external power sources during parking. 2. In the fourth heating device, the hybrid CPU of the hybrid ECU executes a routine illustrated in FIG. 9 in place of the routine illustrated in FIG. 7. Hereinafter, the points of difference are mainly described.

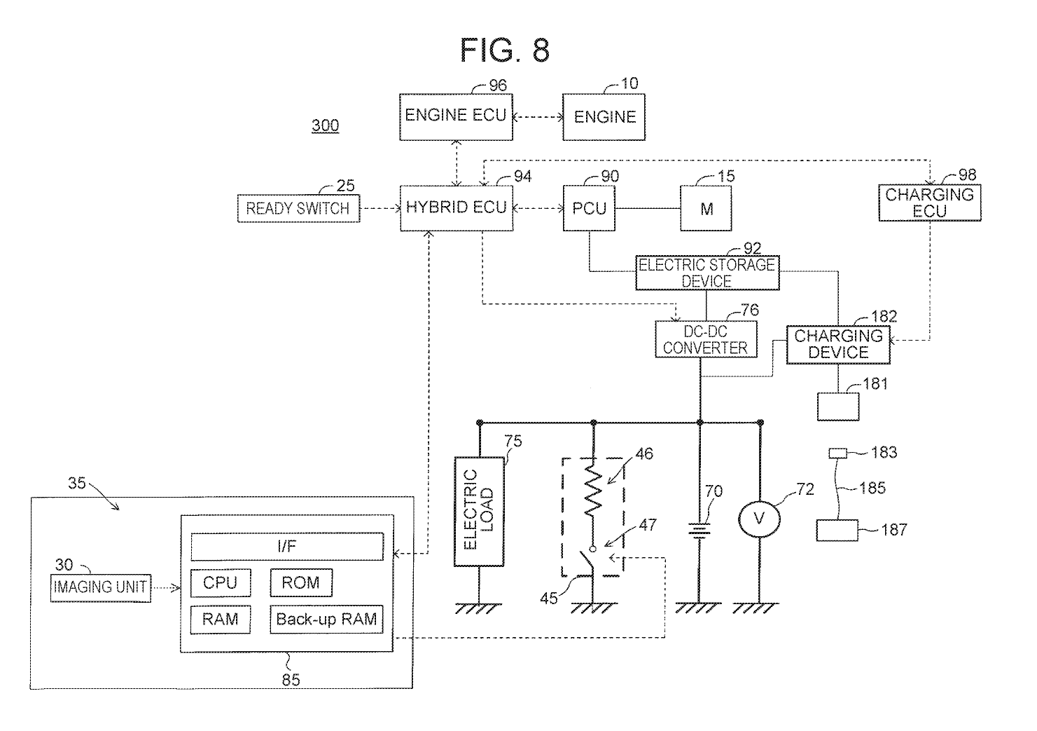

As illustrated in FIG. 8, a vehicle 300 is a plug-in hybrid vehicle including a plug-in hybrid system. Like the vehicle 200, the vehicle 300 includes an engine 10 and a motor 15 that generate driving force for traveling of the vehicle 300, a ready switch 25, a camera 35, a camera heater 45 as a window glass heating device, a battery 70, a voltage detector 72, and an electric load 75. The vehicle 300 also includes a DC-DC converter 76, a power control unit 90, an electric storage device 92, a hybrid ECU 94, and an engine ECU 96. Furthermore, the vehicle 300 includes a charging electronic control unit (referred to as “charging ECU”) 98, a power connection connector 181, and a charging device 182.

The hybrid ECU 94 communicates with the charging ECU 98 to determine whether or not the power connection connector 181 is connected to the power connector 183. Other operation aspects of the hybrid ECU 94 are similar to those described in the third heating device.

The charging ECU 98 is an electronic circuit including a known microcomputer. The charging ECU 98 includes component members such as a CPU, a ROM, a RAM, a backup RAM, and an interface. The CPU implements various functions by executing routines (programs, instructions) stored in the ROM.

The power connection connector 181 is connected to the electric storage device 92 through the charging device 182. The power connection connector 181 is connected to the power connector 183. The power connector 183 is connected to an external power source 187 (for example, a commercial power source) through the cable 185.

The charging device 182 includes an inverter, a first converter, and a second converter. The inverter converts AC power from the external power source 187 into DC power. The first converter converts a voltage from the inverter into a voltage suitable for charging the high voltage battery of the electric storage device 92. The second converter converts the voltage from the inverter into a voltage suitable for charging the battery 70.

When the power connection connector 181 is connected to the power connector 183, at least some of the electric power from the external power source 187 is supplied to the electric storage device 92 and to the battery 70 through the charging device 182, so that the electric storage device 92 and the battery 70 are charged.

When the power connection connector 181 is connected to the power connector 183, and the heater circuit switch 47 is set to an ON state, at least some of the electric power from the external power source 187 is supplied to the heating wire 46 through the charging device 182. That is, electric power is supplied to the heater heating wire 46 from a power supply source other than the battery 70, so that the heater heating wire 46 is energized. The remaining electric power is used to charge the battery 70, or some of the remaining electric power is supplied to component members such as another electric system (air-conditioner) that receives electric power supply from the battery 70.

<Specific Operation>

A description is given of specific operation of the fourth heating device. The hybrid CPU of the fourth heating device executes a routine in the flowchart illustrated in FIG. 9 whenever predetermined time elapses. Therefore, at specified timing, the hybrid CPU starts processing from step 900, and advances the processing to step 910 to determine whether or not satisfaction of permission conditions to energize the heater heating wire 46 by the hybrid CPU is determined. The processing of step 910 is identical to that of step 310 described before.

When the permission conditions to energize the heater heating wire 46 are satisfied, the hybrid CPU determines “Yes” in step 910, and advances the processing to step 920 described later. When the permission conditions to energize the heater heating wire 46 are not satisfied, the hybrid CPU determines “No” in step 910, and advances the processing to step 930 where the present routine is temporarily ended.

In step 920, the hybrid CPU determines whether or not electric power is supplied to the battery 70 from other power supply sources. Specifically, it is determined whether or not the vehicle 300 is in one of the following states: the power connection connector 181 is connected to the power connector 183; and the vehicle 300 is in a Ready state. When the vehicle 300 is in one of the above states, it is determined that electric power is supplied to the battery 70 from other power supply sources. When the vehicle 300 is in neither case, it is determined that no electric power is supplied to the battery 70 from other power supply sources.

When electric power is supplied to the battery 70 from other power supply sources, the hybrid CPU determines “Yes” in step 920, and advances the processing to step 330. Then, in step 330, the hybrid CPU sends out to the camera ECU 85 a signal that instructs permission of the heating wire energization control.

When no electric power is supplied to the battery 70 from other power supply sources, the hybrid CPU determines “No” in step 920, and advances the processing to step 340. Then, in step 340, the hybrid CPU sends out to the camera ECU 85 a signal that instructs prohibition of the heating wire energization control.

Meanwhile, at specified timing, the camera CPU executes the steps same as the steps (processing of steps 400 through 440) illustrated in FIG. 4.

The specific operation of the fourth heating device is as described above. As a consequence, the following effects can be obtained. That is, when electric power is supplied to the heater heating wire 46 from the battery 70 while no electric power is supplied to the battery 70 from other power supply sources (electric storage device 92 and the external power source 187), the remaining capacity of the battery 70 rapidly decreases. On the contrary, in the fourth heating device, when no electric power is supplied to the battery 70 from other power supply sources (electric storage device 92 and the external power source 187), energization of the heater heating wire 46 is not performed. Therefore, the electric power is not supplied to the heater heating wire 46 from the battery 70.

Therefore, it becomes possible to lower the possibility that the remaining amount of the battery 70 decreases to the level where the battery 70 is in the insufficient charging state due to the electric power being supplied to the heater heating wire 46 only from the battery 70. As a result, it becomes possible to lower the possibility that battery exhaustion easily occurs due to such reasons as electric power being supplied from the battery 70 to operate another electrical system (air-conditioner) or an electric appliance included in the vehicle 300 while the battery 70 is in the insufficient charging state.

<Modification>

The present disclosure is not limited to the embodiments disclosed. Various modifications can be adopted within the scope of the present disclosure.

In each of the embodiments, it is not necessary to incorporate the camera ECU in the camera 35.

In the second embodiment, when the low-electric power heating wire energization control is performed, the constant energization continuation time Ton and energization stop time Toff are set in all the cases regardless of the supply voltage. However, the following configuration is also adoptable. That is, at least one of the energization continuation time Ton and the energization stop time Toff may be changed in accordance with the supply voltage. For example, when supply voltage is a given value, the energization continuation time Ton in the low-electric power electric heat control may be set shorter than the energization continuation time Ton in the normal electric power electric heat control.

In each of the third embodiment and the fourth embodiment, the low-electric power heating wire energization control similar to that in the second embodiment may be executed. That is, in each of the embodiments, the processing of step 530 in FIG. 5 may be executed in place of step 430 in FIG. 4.

When the camera 35 is disposed inside the vehicle 100 so as to photograph the outside of the vehicle 100 from the inside of the vehicle 100 through a window glass (rear glass) behind the vehicle 100, the heater 45 may be a heater heating a portion of the rear glass in front of the camera 35. This also applies to each of the vehicle 200 and the vehicle 300.

Furthermore, when the camera 35 is disposed inside the vehicle 100 so as to photograph the outside of the vehicle 100 from the inside of the vehicle 100 through a window glass (side glass) on a lateral side of the vehicle 100, the heater 45 may be a heater heating a portion of the side glass in front of the camera 35. This also applies to each of the vehicle 200 and the vehicle 300.

Furthermore, the vehicle 300 may be a vehicle (so-called an electric vehicle) including not an internal combustion engine but only an electric motor as a driving source of the vehicle.

What is claimed is:

1. A window glass heating device, comprising:
a battery mounted in a vehicle;
a power supply source configured to supply electric power to the battery to charge the battery;
a heating wire configured to generate heat upon reception of electric power, the heating wire being disposed so as to heat a particular part of a window glass of the vehicle, the particular part being located in front of a camera that photographs an outside of the vehicle from an inside of the vehicle through the window glass; and
a control unit configured to control a supply state of electric power supplied to the heating wire, the control unit being configured to:
set the supply state to a first state, when the power supply source supplies electric power to the battery; and
set the supply state to a second state, when the power supply source does not supply electric power to the battery, the second state being smaller in an amount of electric power supplied to the heating wire than the first state.

2. The window glass heating device according to claim 1, wherein
the control unit includes a voltage sensor that detects voltage of the battery,
the control unit switches the supply state between an energized state where electric power is supplied to the heating wire and a cutoff state where supply of electric power to the heating wire is stopped, and
the control unit is configured to:
set the energized state to the first state by repeating an energization control mode including continuing the energized state for a first time in a predetermined time and then continuing the cutoff state for a second time that is equal to a remainder obtained by subtracting the first time from the predetermined time; and
decrease the first time as the detected voltage of the battery is higher.

3. The window glass heating device according to claim 2, wherein
the control unit is configured to, when the power supply source does not supply electric power to the battery, set the supply state to the second state, by repeating an energization control mode including continuing the energized state for a third time and then continuing the cutoff state for a fourth time that is equal to a remainder obtained by subtracting the third time from the predetermined time, and
the third time is shorter than the first time, when the detected voltage of the battery is a prescribed voltage.

4. The window glass heating device according to claim 1, wherein
the control unit switches the supply state between an energized state where electric power is supplied to the heating wire and a cutoff state where supply of electric power to the heating wire is stopped,
the control unit is configured to:
when setting the supply state to the first state, repeat an energization control including continuing the energized state for a first time and then continuing the cutoff state for a second time that is equal to a remainder obtained by subtracting the first time from a predetermined time; and
when the power supply source does not supply electric power to the battery, set the supply state to the second state by repeating an energization control mode including continuing the energized state for a third time and then continuing the cutoff state for a fourth time that is equal to a remainder obtained by subtracting the third time from the predetermined time, and
the third time is shorter than the first time.

5. The window glass heating device according to claim 2, wherein
the control unit is configured to, when the power supply source does not supply electric power to the battery, repeat set the supply state to the second state by repeating an energization control mode including continuing the energized state for a fifth time and then continuing the cutoff state for a sixth time that is equal to a remainder obtained by subtracting the fifth time from the predetermined time, and
the fifth time is set, regardless of the detected voltage of the battery, equal to or shorter than a shortest continuation time among the first time.

6. The window glass heating device according to claim 1, wherein
the heating wire is attached to a support member that supports the camera to the vehicle the camera, and the window glass, so as to heat a closed space formed with the support member.

7. The window glass heating device according to claim 1, wherein
when the power supply source does not supply electric power to the battery, the control unit sets the supply state to the second state by continuing a cutoff state where supply of electric power to the heating wire is stopped.
